(19) United States
(12) Patent Application Publication
(10) Pub. No.: US 2020/0344532 A1
(43) Pub. Date: Oct. 29, 2020

(54) SELECTIVELY TRANSITIONING A DISPLAY SCREEN OF A HUMAN-OPERABLE APPARATUS BETWEEN A RESTRICTED MODE AND AN UNRESTRICTED MODE BASED UPON MOTION AND/OR PROXIMITY DETECTION

(71) Applicant: Route 1 Inc., Toronto (CA)

(72) Inventor: Jerry S. IWANSKI, Scottsdale (AZ)

(21) Appl. No.: 16/858,147

(22) Filed: Apr. 24, 2020

Related U.S. Application Data
(60) Provisional application No. 62/838,843, filed on Apr. 25, 2019.

(51) Int. Cl. H04Q 9/00; G09G 5/00

(52) U.S. Cl. CPC H04Q 9/00; G09G 5/00; B66F 9/0755; G09G 2380/10; G09G 2354/00

(57) ABSTRACT

In an embodiment, a controller receives, from one or more sensors associated with a human-operable apparatus while at least one display screen associated with the apparatus is in either a restricted mode or a unrestricted mode, sensor data that tracks motion and/or proximity of one or more apparatus components and/or a surrounding environment of the apparatus. The controller further determines whether to switch between the restricted and unrestricted modes based on the sensor data. In one aspect, the restricted mode is characterized by a portion that comprises less than all of the at least one display screen being masked, and the unrestricted mode is characterized by the portion of the at least one display screen being unmasked. In another aspect, the one or more sensors are configured to track at least non-propulsive motion of the human-operable apparatus (e.g., such as a forklift arm).

### CROSS-REFERENCE TO RELATED APPLICATIONS

The present Application for Patent claims the benefit of Provisional Patent Application No. 62/838,843 entitled “SELECTIVELY TRANSITIONING A DISPLAY SCREEN OF A HUMAN-OPERABLE APPARATUS BETWEEN A RESTRICTED MODE AND AN UNRESTRICTED MODE BASED UPON MOTION AND/OR PROXIMITY DETECTION”, filed Apr. 25, 2019, and assigned to the assignee hereof and hereby expressly incorporated herein by reference in its entirety.

### INTRODUCTION

Aspects of this disclosure relate generally to selectively transitioning a display screen of a human-operable apparatus between a restricted mode and an unrestricted mode based upon motion and/or proximity detection.

It is generally known that human operators of apparatuses such as vehicles, construction cranes, etc., can become distracted by devices with display screens, which can increase the risk of accidents. However, it is often beneficial for display screens to be mounted onto such apparatuses in a convenient location (e.g., on a dashboard) so as to be accessible when the apparatuses are not in active use (e.g., when vehicles are not in motion, when construction equipment such as cranes or forklifts are not in operation, etc.).

Conventional solutions to the human operator distraction problem rely upon Global Positioning Satellite (GPS) signals, vehicle propulsion component measurements (e.g., speedometers, transmission gear position indicator, brake setting, accelerometers, etc.) to detect motion of an apparatus such as a vehicle, which then triggers an associated display screen to turn off (or blank). However, these motion detection techniques have drawbacks.

For example, the GPS-based approach does not function reliably indoors, it lacks accuracy in determining velocity and acceleration for relatively short and slow movements, and is constrained in its ability to determine the orientation of the vehicle. In another example, vehicle propulsion component-based approaches (e.g., speedometers, transmission gear position indicator, brake setting, accelerometers, etc.) are fairly limited in terms of the type of motion that is detectable. In a specific example, accelerometer-based approaches become unreliable when subjected to a large amount of environmental vibration, and lack accuracy in determining absolute velocity.

Finally, both GPS-based and accelerometer-based approaches take a relatively long time to blank a display screen of a vehicle after that vehicle starts to move. For example, consider a forklift in a factory, where GPS-based and accelerometer-based approaches require 4 or more seconds before the vehicle motion is detected and the display screen is blanked. In this time period, the forklift could already have moved over 22 meters before the display screen is blanked. This period of motion (before screen blanking) is associated with an increased accident risk due to potential driver distraction as noted above.

### SUMMARY

In an embodiment, a controller of a screen control system receives, from one or more sensors associated with a human-operable apparatus while at least one display screen associated with the apparatus is in an unrestricted mode, sensor data that tracks motion and/or proximity of one or more apparatus components and/or a surrounding environment of the apparatus, and determines whether to transition the at least one display screen into a restricted mode based on the sensor data. In a further aspect, the restricted mode is characterized by a portion that comprises less than all of the at least one display screen being masked, and the unrestricted mode is characterized by the portion of the at least one display screen being unmasked, or the one or more sensors are configured to track at least non-propulsive motion of the one or more apparatus components of the human-operable apparatus, or a combination thereof.

In another embodiment, a controller of a screen control system receives, from one or more sensors associated with a human-operable apparatus while at least one display screen associated with the apparatus is in a restricted mode, sensor data that tracks motion and/or proximity of one or more apparatus components and/or a surrounding environment of the apparatus, and determines whether to transition the at least one display screen into an unrestricted mode based on the sensor data. In a further aspect, the restricted mode is characterized by a portion that comprises less than all of the at least one display screen being masked, and the unrestricted mode is characterized by the portion of the at least one display screen being unmasked, or the one or more sensors are configured to track at least non-propulsive motion of the one or more apparatus components of the human-operable apparatus, or a combination thereof.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates a screen control system in accordance with an embodiment of the disclosure.

FIG. 2 illustrates a communications network in accordance with an embodiment of the disclosure.

FIG. 3 illustrates a screen control process in accordance with an embodiment of the present disclosure.

FIG. 4 illustrates a screen control process in accordance with an embodiment of the present disclosure.

FIG. 5 illustrates an example implementation of the processes of FIGS. 3-4 in accordance with an embodiment of the disclosure.

FIG. 6 illustrates an example implementation of the processes of FIGS. 3-4 in accordance with another embodiment of the disclosure.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), an FPGA, by program instructions being executed by one or more general purpose processors, or by a combination of the above. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter.

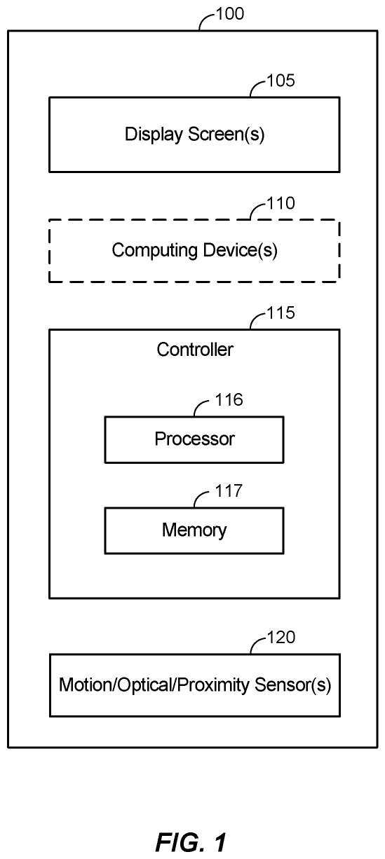

FIG. 1 illustrates a screen control system 100 in accordance with an embodiment of the disclosure. In some designs, one or more of the various components of the screen control system 100 may be mounted onto (or integrated into) a human-operable apparatus, including industrial apparatuses such as an industrial vehicle (e.g., a tractor trailer, forklift or truck lift, etc.), construction equipment such as a crane, and so on.

The screen control system 100 includes at least one display screen 105, a controller 115, and at least one motion, optical or proximity sensor 120. The vehicle computing system 100 optionally includes at least one computing device 110 that controls (e.g., provides frame output to) the at least one display screen 105. In an example, the computing device 110 as a separate component of the screen control system 100 is optional as this functionally may alternatively be integrated into the controller 115, with the controller 115 controlling (e.g., providing frame output to) the at least one display screen 105 itself. Each of the components 105-120 may include various hardware (e.g., one or more processors, one or more wired or wireless transceivers, a memory, etc.) and software to facilitate their associated functionality. As used herein, the “motion” that is detectable by the motion, optical or proximity sensor 120 may comprise propulsive motion (e.g., wheel movement, vehicle acceleration, brake and/or transmission settings or configuration, etc.), or non-propulsive motion (e.g., movement of apparatus parts unrelated to propulsion, such as a crane or forklift arm being moved, windows being raised/lowered, a clamp being tightened/loosened, mirrors being adjusted, such as rearview mirror, side mirrors and/or blindspot mirror, etc.).

Referring to FIG. 1, the controller 115 may comprise at least one processor 116 and a memory 117. The at least one processor 116 may comprise a programmable logic controller (PLC) in accordance with an embodiment of the present disclosure. In other embodiments, the at least one processor 116 may comprise a non-PLC microcontroller, such as a Raspberry Pi.

Referring to FIG. 1, in some designs, the at least one motion, optical or proximity sensor 120 may include one or more magnetic induction sensors (or shaft encoders). For example, each magnetic induction sensor (or shaft encoder) may be placed near a metal rotating part (e.g., an axle or wheel, etc.) of an associated apparatus to read a frequency of rotation. The magnetic induction sensor (or shaft encoder) may signal the controller 115 either continuously or in an event-triggered manner (e.g., when the rotational frequency rises above or falls below a threshold) to convey the frequency of rotation, from which a velocity and/or acceleration can be estimated.

Referring to FIG. 1, in some designs, the at least one motion, optical or proximity sensor 120 may include one or more optical image sensors (e.g., cameras) that focus upon (i) a metal rotating part of an associated apparatus to capture a frequency of rotation, (ii) a surrounding environment of the apparatus, (iii) a non-propulsion functional component of the apparatus (e.g., a moving part that is not propulsion-centric, such as a crane arm, forklift arm, a clamp, etc.), or (iv) any combination thereof. In case of (i), the at least one motion, optical or proximity sensor 120 may send an image or video feed to the controller 115, which analyzes the image or video feed to determine the motion (e.g., propulsive and/or non-propulsive motion), from which the vehicular velocity and/or acceleration can be estimated. In case of (ii), the relative change in orientation of stationary objects in the surrounding environment can be used to indicate the velocity and/or acceleration of the vehicle. In case of (iii), the one or more optical image sensors can capture a functional component that is not related to propulsive motion of the apparatus itself, such as the arm of a construction crane or the forks (or arms) of a forklift. In this case, the crane or forklift itself can be stationary with a moving part (e.g., crane or fork) whose motion is being tracked with regard to screen control.

Referring to FIG. 1, in some designs, the at least one motion, optical or proximity sensor 120 may include one or more proximity sensors that track a proximity to a component such as a clamp.

Referring to FIG. 1, in some designs, the at least one motion, optical or proximity sensor 120 may include one or more laser emitters and sensors (e.g., LIDAR) that track proximity and/or motion relative to a component and/or to objects in the surrounding environment of the apparatus.

Referring to FIG. 1, in some designs, the at least one motion, optical or proximity sensor 120 may be mounted onto (or integrated into) the human-operable apparatus. However, in other designs, one or more of the sensors may be separate from the human-operable apparatus (i.e., ‘external’ sensors). For example, an external camera can be setup to capture an arm of a crane, with a video feed from the camera streaming to the controller 115 to track movement of the arm. In this case, the camera need not be integrated into the crane itself, although in some designs this is possible as well (e.g., in some designs, a combination of external and internal sensors of the same type can be used for redundancy, such as a combination of apparatus-integrated and external cameras).

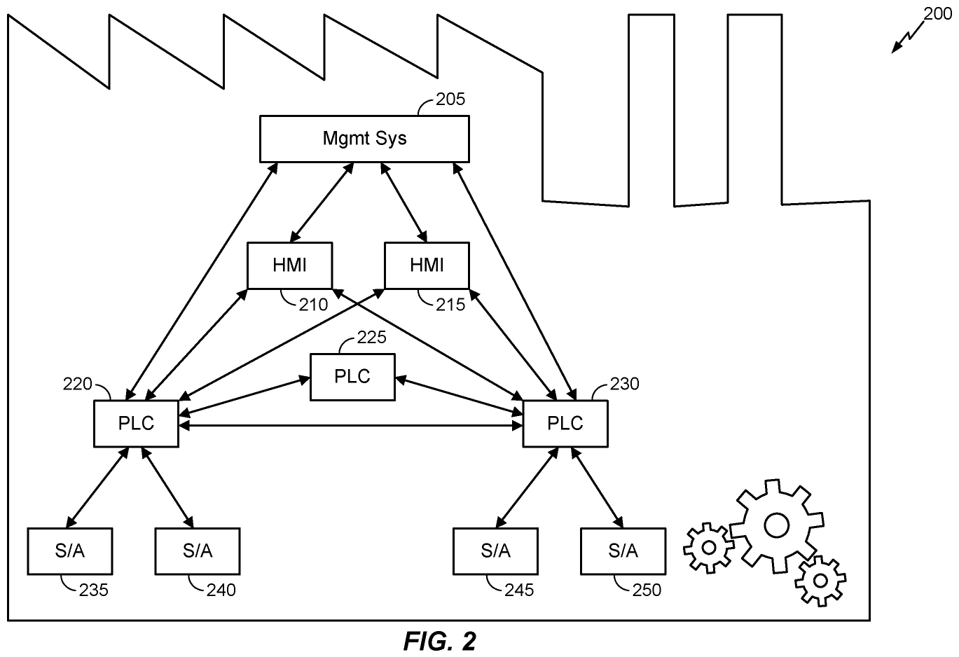

FIG. 2 illustrates a communications network 200 in accordance with an embodiment of the disclosure. In particular, the communications network 200 of FIG. 2 represents an example of an industrial IoT network (e.g., for monitoring and/or controlling various devices or sensors deployed in a factory setting) in which an apparatus comprising the screen control system 100 of FIG. 1 may be deployed.

In an example, wireless communication may be implemented in the communications network 200 in accordance with a wireless communications protocol, including but not limited to Wireless Speaker & Audio Association (WISA) based on an IEEE 802.15.1 (Bluetooth) PHY with a modified MAC layer (e.g., up to 15 ms latency with 10e-9 reliability), Wireless Highway Addressable Remote Transducer Protocol (WirelessHART) based on IEEE 802.15.4 (ZigBee) PHY/MAC (e.g., for factory automation with low-power sensors), or 5G URLLC Rel. 15 based on a mini-slot structure with URLLC-specific signaling (e.g., sPDCCH, SR, Indicator, etc.).

Referring to FIG. 2, the communications network 200 includes a management system 205, human machine interfaces (HMIs) 210-215, PLCs 220-230 and sensor/actuators (S/As) 235-250. In FIG. 2, the various communicative interconnections (or arrows) between the various network components may correspond to wired or wireless communications interfaces.

Referring to FIG. 2, the management system 205 includes controller programming, manages software and security for the communications network 200, and performs long-term key performance indicator (KPI) monitoring. The HMIs 210-215 include user devices (e.g., tablet computers, panels, wearable computers, etc.). For example, the HMIs 210-215 may permit machine control by authorized personnel at the factory floor (e.g., Start/Stop certain machinery, change a mode of a particular machine from ‘widget 1’ to ‘widget 2’, etc.). The HMIs 210-215 may optionally provide an augmented reality (AR) user interface or a virtual reality (VR) user interface, either of which may correspond to one of the display screen(s) 105.

Referring to FIG. 2, the PLCs 220-230 may communicate with the S/As 235-250. For example, the PLCs 220-230 may include custom hardware and may issue commands (e.g., motion control) to the S/As 235-250, and may receive sensor inputs (e.g., position data, velocity data, etc.) from the S/As 235-250 in real-time. The various PLCs 220-230 may also coordinate with each other with respect to S/A control. In an example, the S/As 235-250 may include rotary motors, linear servomotors and/or position/motion sensors.

Referring to FIGS. 1-2, in an example, the motion, optical or proximity sensor(s) 120 may correspond to one or more of S/As 235-250, the controller 115 may correspond to one of PLCs 220-230, and the display screen(s) 105 and computing device(s) 110 may correspond to one or more of HMIs 210-215. As noted above, the various communicative couplings between the devices may be either wired or wireless.

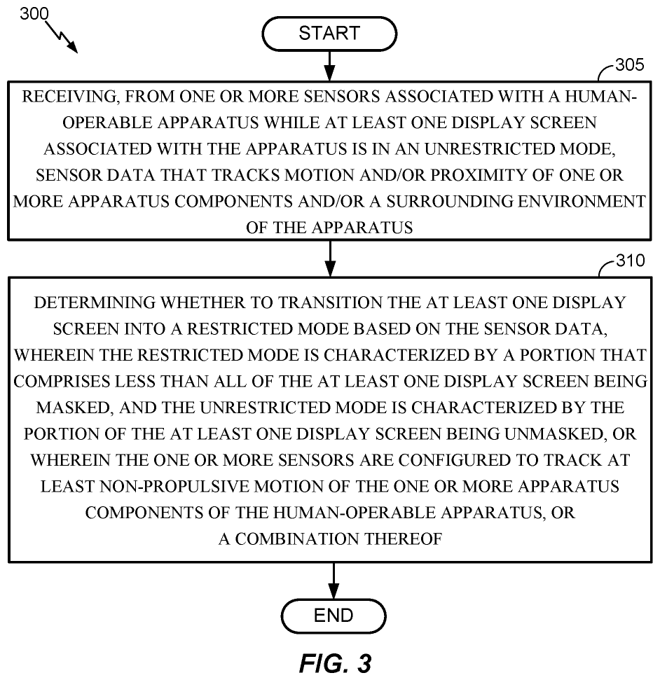

FIG. 3 illustrates a screen control process 300 in accordance with an embodiment of the present disclosure. The screen control process 300 is performed by a controller, such as the controller 115 of FIG. 1 (e.g., a PLC, a non-PLC microcontroller, etc.).

Referring to FIG. 3, at 305, the controller receives, from one or more sensors associated with a human-operable apparatus while at least one display screen associated with the apparatus is in an unrestricted mode, sensor data that tracks motion and/or proximity of one or more apparatus components and/or a surrounding environment of the apparatus. In an aspect, the restricted mode is characterized by a portion that comprises less than all of the at least one display screen being masked, and the unrestricted mode is characterized by the portion of the at least one display screen being unmasked. In another aspect, the one or more sensors are configured to track at least non-propulsive motion of the one or more apparatus components of the human-operable apparatus (e.g., movement of a crane arm or a forklift arm, windows opening/closing, seats reclining/inclining, mirrors such as rearview mirrors, sideview mirrors of blindspot mirrors being adjusted, etc.). Some combination of the above-noted aspects may also be implemented in some designs. In an example, the apparatus is a vehicle, although in other embodiments the apparatus may be implemented as a stationary machine with one or more non-propulsive moving parts. In an example, the one or more sensors may include one or more internal sensors (e.g., mounted onto or integrated into the apparatus), one or more external sensors (e.g., separate of independent from the apparatus) or a combination thereof. Hence, the association between the sensor(s) and the apparatus can be an internal/integrated association or an external/separated association.

In an example, the sensor data received at 305 may be provided in the form of raw data (e.g., rotation frequency of the rotating components, image/video data that captures movement of one or more apparatus components, etc.) that requires processing at the controller to derive an associated velocity and/or acceleration. Alternatively, some intelligence can be integrated into the sensor(s) (or an intermediate processing device) such that the sensor data can be provided in a more refined format (e.g., indicative of an actual velocity and/or acceleration).

In an example, the sensor data received at 305 can indicate not only a speed of the apparatus (or apparatus component), but also an associated direction of movement. For example, the sensor data can be used to infer whether a vehicle is moving forward or in reverse or spinning in a circle, or whether a construction crane arm is moving left or right (relative to some frame of reference, such as a driver field of view orientation if the apparatus is a vehicle), or whether a forklift fork is moving up or down or extending/retracting, etc.

Referring to FIG. 3, at 310, the controller determines whether to transition the at least one display screen into a restricted mode based on the sensor data. For example, the controller may determine to transition the at least one display screen into the restricted mode based on whether the sensor data indicates the apparatus (e.g., vehicle) or apparatus component (e.g., crane arm, forklift fork, etc.) to be moving in excess of a velocity threshold (e.g., 2 MPH, 3 MPH, etc.) or an acceleration threshold (e.g., 0.5 m/s², etc.). In an example, the various thresholds may be neutral in terms of direction (e.g., for a vehicle, whether the vehicle is moving forward or in reverse, positive or negative acceleration, etc.), or alternatively different thresholds can be defined for particular directions (e.g., 2 MPH is threshold for forward velocity and 1 MPH is threshold for reverse velocity, 0.5 m/s² is threshold for positive acceleration while 0.2 m/s² is threshold for negative acceleration or braking, etc.). As noted above, there may be more than one restricted mode available, such that a mode transition implemented based on the determination of 310 may be (i) from unrestricted mode to a restricted mode, or (ii) from one restricted mode to another restricted mode. Hence, as used herein, designations of a restricted mode or an unrestrictive mode are relative. For example, consider three modes denoted as Mode_1, Mode_2 and Mode_3 that are associated with different levels of masking. In Mode_1, 10% of a display screen is masked (e.g., based on one or more rules, such as masking of text only), in Mode_2, 25% of the display screen is masked (e.g., based on or more rules, such as masking of text and images), and in Mode_3, 75% of the display screen is masked (e.g., based on or more rules, such as masking of all screen content except for a few white-listed data types such as a clock, a current speed, navigational data, etc.). Here, Mode_2 is restricted relative to Mode_1, while Mode_2 is unrestricted relative to Mode_3. It is also possible or Modes to simply be different in terms of restriction (e.g., Mode_1 restricts first screen content while permitting second screen content, while Mode_2 restricted second screen content while permitting first screen content), in which case restricted or unrestricted status may be defined in terms of screen element per screen element rather than from mode to mode.

In some designs, the restricted mode is characterized by the at least one display screen being blanked or masked, and the unrestricted mode is characterized by the at least one display screen not being blanked or masked. Blanking is a type of masking whereby the entire display screen output is hidden (total mask), while masking more broadly covers blanking as well as partial masking of the display screen (i.e., less than all of the display screen is hidden from view). In an example, if masking is used, the mask can be positive (e.g., specify what to show) or negative (e.g., specify what not to show) or a combination thereof (e.g., hide text content while permitting the date/time to be displayed, etc.). In a further example, the mask can be defined in terms of screen coordinates (e.g., sequence X₁,Y₁,X₂,Y₂ coordinate sets), although the mask may alternatively be defined as a bitmap (e.g., each bit position on the display screen is mapped to a Boolean indicator that indicates whether or not that bit is to be masked). In some designs, different masks can be triggered by different criteria (e.g., total masking or blanking of screen is triggered at velocities over 10 MPH, while partial masking is permitted between 2-10 MPH, etc., total masking or blanking of screen is triggered in hazardous areas while partial masking of screen is permitted in less hazardous areas, etc.). In some designs, the restricted mode may lock the display screen (e.g., freeze frame), dim the display screen, disable a touch-based input function for touch screen display screen, provide a user alert or warning on the display screen, and so on. Further, it is understood that unrestricted mode refers to the display screen being non-restricted from the standpoint of a motion-based safety control scheme, and the display screen could be under other types of restriction (e.g., login requirements, etc.) that are outside the scope of the motion-based safety control scheme.

In an implementation where the controller is communicatively coupled to a computing device that controls the at least one display screen and the controller determines to transition the at least one display screen into the restricted mode, the controller may send a signal to the computing device to trigger the computing device to transition the at least one display screen into the restricted mode. Alternatively, in an implementation where the controller itself directly controls the at least one display screen and the controller determines to transition the at least one display screen into the restricted mode, the controller transitions the at least one display screen into the restricted mode itself (e.g., by masking a video feed to the at least one display screen, etc.). In either case, a time period from the determination of 310 to the signal transmission or mode transition can occur in less than about 1 second in some implementations (e.g., in some designs, less than 100 ms, and in some designs, less than 10 ms), which is quicker than the 4 or more seconds typically required by GPS-based and accelerometer-based approaches. In practical terms, in some factory environments, this means that a forklift can have its screen masked after traveling approximately 5 (or fewer) feet instead of 22 (or more) meters, which reduces the risk (in terms of both frequency and severity) of accidents.

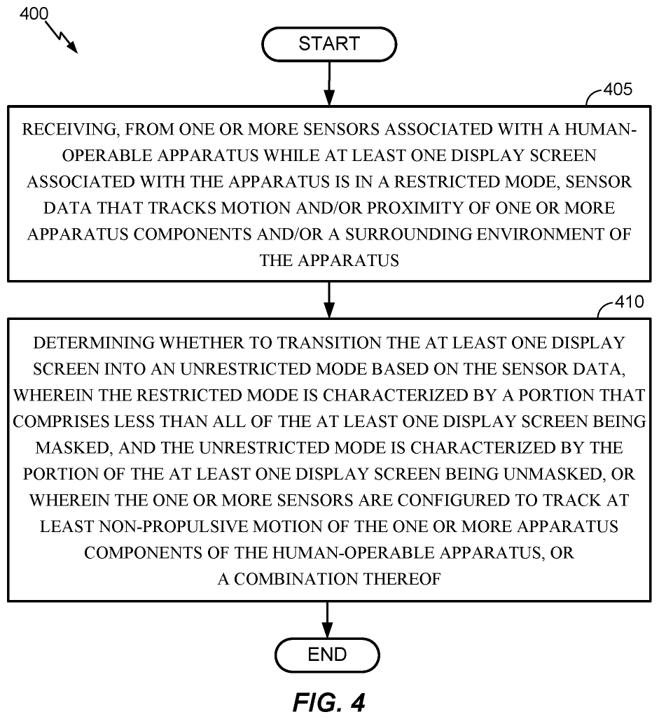

FIG. 4 illustrates a screen control process 400 in accordance with an embodiment of the present disclosure. The screen control process 400 is performed by a controller, such as the controller 115 of FIG. 1 (e.g., a PLC, a non-PLC microcontroller, etc.).

Referring to FIG. 4, at 405, the controller receives, from one or more sensors associated with a human-operable apparatus while at least one display screen associated with the apparatus is in a restricted mode, sensor data that tracks motion and/or proximity of one or more apparatus components and/or a surrounding environment of the apparatus. In an aspect, the restricted mode is characterized by a portion that comprises less than all of the at least one display screen being masked, and the unrestricted mode is characterized by the portion of the at least one display screen being unmasked. In another aspect, the one or more sensors are configured to track at least non-propulsive motion of the one or more apparatus components of the human-operable apparatus (e.g., movement of a crane arm or a forklift arm, windows opening/closing, seats reclining/inclining, mirrors such as rearview mirrors, sideview mirrors of blindspot mirrors being adjusted, etc.). Some combination of the above-noted aspects may also be implemented in some designs.

In an example, the sensor data received at 405 is similar to or the same as the sensor data received at 305 of FIG. 3. As noted above, in an example, the one or more sensors may include one or more internal sensors (e.g., mounted onto or integrated into the apparatus), one or more external sensors (e.g., separate of independent from the apparatus) or a combination thereof. Hence, the association between the sensor(s) and the apparatus can be an internal/integrated association or an external/separated association.

Referring to FIG. 4, at 410, the controller determines whether to transition the at least one display screen into an unrestricted mode based on the sensor data. For example, the controller may determine to transition the at least one display screen into the unrestricted mode based on whether the sensor data indicates the apparatus (e.g., vehicle) or apparatus component (e.g., crane arm, forklift fork, etc.) to be moving at less than a velocity threshold (e.g., 2 MPH, 3 MPH, etc.) or an acceleration threshold (e.g., 0.5 m/s², etc.).

In an example, the velocity and/or acceleration thresholds used to trigger a transition from the restricted mode to the unrestricted mode may be the same as the velocity and/or acceleration thresholds used to trigger a transition from the unrestricted mode to the restricted mode as described above with respect to FIG. 3. Alternatively, respective velocity and/or acceleration thresholds may be offset from each other by a guard interval to avoid a ‘ping-ponging’ effect (e.g., where the display screen quickly toggles back and forth between masked/unmasked display modes which can itself be distracting to the driver). For example, if 2 MPH is the velocity threshold for triggering a transition from the unrestricted mode to the restricted mode, a lower velocity threshold (e.g., 1 MPH, 1.5 MPH, etc.) can be used to trigger a transition from the restricted mode back to the unrestricted mode.

In an implementation where the controller is communicatively coupled to a computing device that controls the at least one display screen and the controller determines to transition the at least one display screen into the unrestricted mode, the controller may send a signal to the computing device to trigger the computing device to transition the at least one display screen into the unrestricted mode. Alternatively, in an implementation where the controller itself directly controls the at least one display screen and the controller determines to transition the at least one display screen into the unrestricted mode, the controller transitions the at least one display screen into the unrestricted mode itself (e.g., by unmasking a video feed to the at least one display screen, etc.). In either case, a time period from the determination of 410 to the signal transmission or mode transition can occur in less than about 1 second in some implementations (e.g., in some designs, less than 100 ms, and in some designs, less than 10 ms), which is quicker than the 4 or more seconds typically required by GPS-based and accelerometer-based approaches. In practical terms, in some factory environments, this means that a forklift can have its screen unmasked more quickly, which increases efficiency without increasing an associated risk of accident.

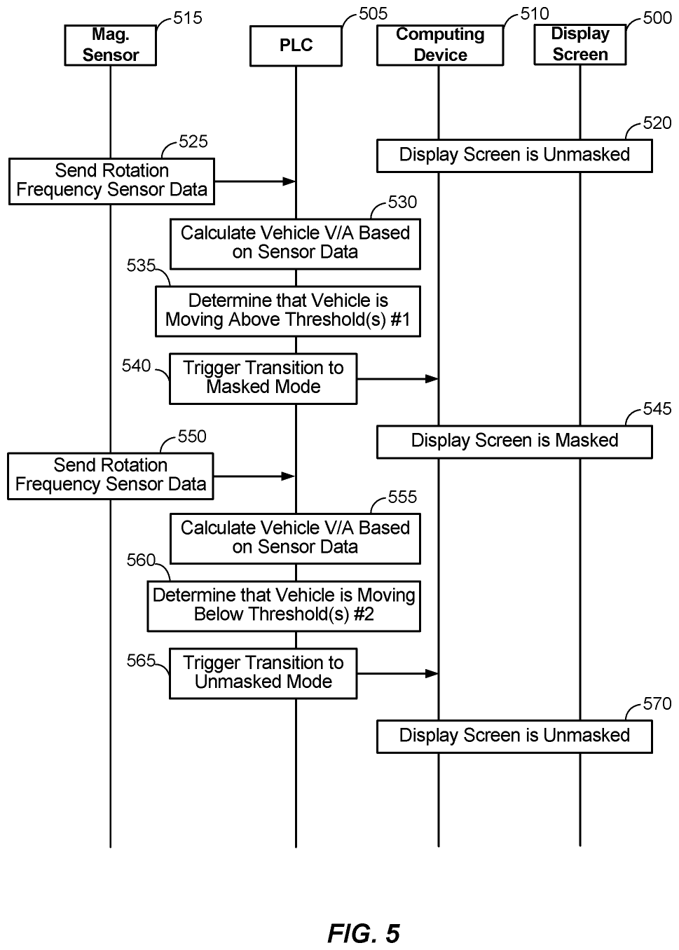

FIG. 5 illustrates an example implementation of the processes 300-400 of FIGS. 3-4 in accordance with an embodiment of the disclosure. For convenience of explanation, the process of FIG. 5 is described with certain operational assumptions that need not occur in all implementations of the processes 300-400 of FIGS. 3-4, including:
The human-operable apparatus is a vehicle, with a velocity/acceleration of the vehicle being the trigger for masking/unmasking of the display screen 500 (e.g., as opposed to the velocity/acceleration of a moving part of the apparatus, such as the arm of a construction crane or fork of a forklift),
A single display screen 500 is used,
The controller comprises a PLC 505,
A computing device 510 communicatively coupled to the PLC 505 directly controls the output of the display screen 500,
The motion/proximity sensors include a magnetic induction sensor 510 which sends raw rotation frequency sensor data to the PLC 505,
The restricted mode corresponds to masking of the display screen 500,
Different velocity/acceleration thresholds are used to trigger masking/unmasking of the display screen 500.

Referring to FIG. 5, at 520, assume that the display screen 500 is in an unmasked state (e.g., no content is hidden on the display screen 500). At 525, the magnetic induction sensor 515 (which tracks motion of a rotating component of the vehicle, such as an axle or wheel) sends rotation frequency sensor data to the PLC 505. In an example, the transmission at 525 can occur on a continuous (or periodic) basis, or alternatively may occur in an event-triggered manner (e.g., in response to polling from the PLC 505, etc.). At 530, the PLC 505 calculates velocity and/or acceleration of the vehicle based on the rotation frequency sensor data received at 525. At 535, assume that the PLC 505 determines that the velocity and/or acceleration calculated at 530 exceeds one or more velocity and/or acceleration thresholds (e.g., 2 MPH, 0.5 m/s², etc.). At 540, the PLC 505 sends a signal to the computing device 510 to trigger a transition of the display screen 500 into the masked mode. At 545, the computing device 510 transitions the display screen 500 into the masked mode (e.g., a partial mask where some but not all of the display screen 500 is obfuscated, or a complete mask or blanking where all of the display screen 500 if obfuscated).

Referring to FIG. 5, at some later point in time, at 550, the magnetic induction sensor 510 sends supplemental rotation frequency sensor data to the PLC 505. Similar to 525, in an example, the transmission at 550 can occur on a continuous (or periodic) basis, or alternatively may occur in an event-triggered manner (e.g., in response to polling from the PLC 505, etc.). At 555, the PLC 505 calculates velocity and/or acceleration of the vehicle based on the rotation frequency sensor data received at 545. At 560, assume that the PLC 505 determines that the velocity and/or acceleration calculated at 545 is below a different set of velocity and/or acceleration thresholds (e.g., 1.5 MPH, 0.2 m/s², etc.), etc.). At 565, the PLC 505 sends a signal to the computing device 510 to trigger a transition of the display screen 500 into the unmasked mode. At 570, the computing device 510 transitions the display screen 500 into the unmasked mode (i.e., unmasks the display screen).

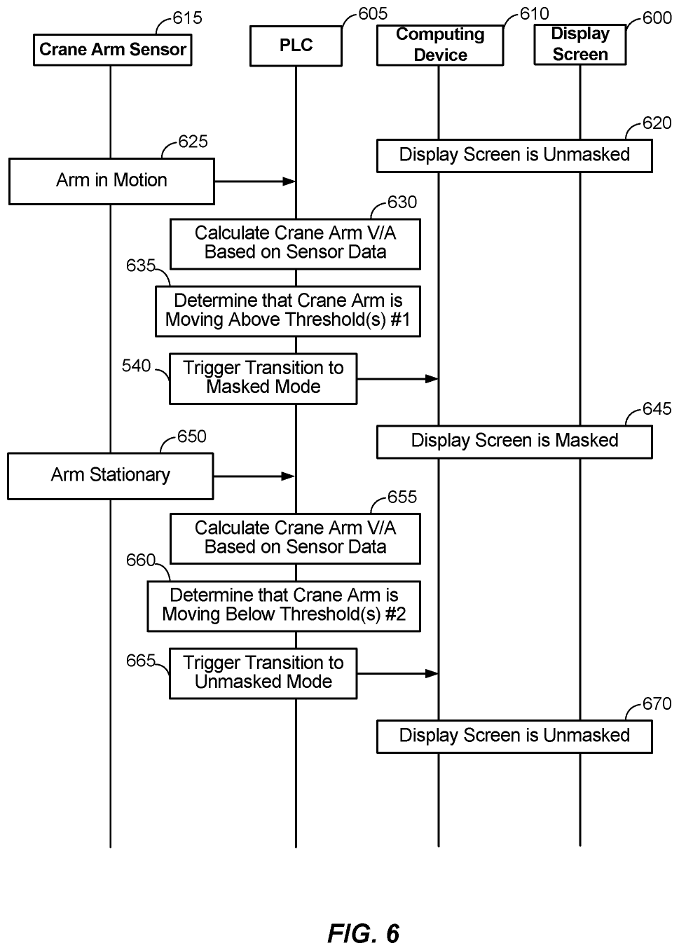

FIG. 6 illustrates an example implementation of the processes 300-400 of FIGS. 3-4 in accordance with another embodiment of the disclosure. For convenience of explanation, the process of FIG. 6 is described with certain operational assumptions that need not occur in all implementations of the processes 300-400 of FIGS. 3-4, including:
The human-operable apparatus is a crane, with a velocity/acceleration of the crane arm of the crane being the trigger for masking/unmasking of the display screen 600 (e.g., as opposed to the velocity/acceleration associated with the propulsion of the crane),
A single display screen 600 is used,
The controller comprises a PLC 605,
A computing device 610 communicatively coupled to the PLC 605 directly controls the output of the display screen 600,
The motion/proximity sensors include a crane arm sensor 610 (e.g., an accelerometer mounted on the crane arm, a video camera capturing the train arm, etc.) which sends crane arm sensor data to the PLC 605,
The restricted mode corresponds to masking of the display screen 600,
Different velocity/acceleration thresholds are used to trigger masking/unmasking of the display screen 600.

Referring to FIG. 6, at 620, assume that the display screen 600 is in an unmasked state (e.g., no content is hidden on the display screen 600). At 625, the crane arm sensor 615 (which tracks motion of the crane arm) sends crane arm sensor data to the PLC 605. In an example, the transmission at 625 can occur on a continuous (or periodic) basis, or alternatively may occur in an event-triggered manner (e.g., in response to polling from the PLC 605, in response to the crane being turned on, etc.). At 630, the PLC 605 calculates velocity and/or acceleration of the crane arm based on the crane arm sensor data received at 625. At 635, assume that the PLC 605 determines that the velocity and/or acceleration calculated at 630 exceeds one or more velocity and/or acceleration thresholds (e.g., 2 MPH, 0 MPH, 0.5 m/s², etc.). At 640, the PLC 605 sends a signal to the computing device 610 to trigger a transition of the display screen 600 into the masked mode. At 645, the computing device 610 transitions the display screen 600 into the masked mode (e.g., a partial mask where some but not all of the display screen 600 is obfuscated, or a complete mask or blanking where all of the display screen 600 if obfuscated).

Referring to FIG. 6, at some later point in time, at 650, the crane arm sensor 610 sends supplemental rotation frequency sensor data to the PLC 605. Similar to 625, in an example, the transmission at 650 can occur on a continuous (or periodic) basis, or alternatively may occur in an event-triggered manner (e.g., in response to polling from the PLC 605, etc.). At 655, the PLC 605 calculates velocity and/or acceleration of the crane based on the crane arm sensor data received at 645. At 660, assume that the PLC 605 determines that the velocity and/or acceleration calculated at 645 is below a different set of velocity and/or acceleration thresholds (e.g., 1.5 MPH, 0.2 m/s², etc.), etc.). At 665, the PLC 605 sends a signal to the computing device 610 to trigger a transition of the display screen 600 into the unmasked mode. At 670, the computing device 610 transitions the display screen 600 into the unmasked mode (i.e., unmasks the display screen).

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for communication.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of operating a controller of a screen control system, comprising:
receiving, from one or more sensors associated with a human-operable apparatus while at least one display screen associated with the apparatus is in an unrestricted mode, sensor data that tracks motion and/or proximity of one or more apparatus components and/or a surrounding environment of the apparatus; and
determining whether to transition the at least one display screen into a restricted mode based on the sensor data,
wherein the restricted mode is characterized by a portion that comprises less than all of the at least one display screen being masked, and the unrestricted mode is characterized by the portion of the at least one display screen being unmasked, or
wherein the one or more sensors are configured to track at least non-propulsive motion of the one or more apparatus components of the human-operable apparatus, or
a combination thereof.

2. The method of claim 1, wherein the one or more sensors are configured to track at least the non-propulsive motion of the human-operable apparatus.

3. The method of claim 2, wherein the sensor data is further configured to track propulsive motion of the human-operable apparatus, non-propulsive motion of the human-operable apparatus, or a combination thereof.

4. The method of claim 1,
wherein the apparatus is a vehicle, or
wherein the apparatus is a stationary machine with one or more moving parts.

5. The method of claim 1, wherein the sensor data indicates a velocity and/or acceleration of the apparatus or one or more non-propulsive moving parts of the apparatus.

6. The method of claim 1, wherein the determining determines to transition the at least one display screen into the restricted mode based on whether the sensor data indicates the apparatus and/or the one or more apparatus components to be moving in excess of velocity and/or acceleration thresholds.

7. The method of claim 1, wherein the restricted mode is characterized by the at least one display screen being blanked or completely masked, and the unrestricted mode is characterized by the at least one display screen being unblanked or completely viewable.

8. The method of claim 1, wherein the restricted mode is characterized by the portion that comprises less than all of the at least one display screen being masked, and the unrestricted mode is characterized by the portion of the at least one display screen being unmasked.

9. The method of claim 8, wherein a mask applied during the restricted mode is configured as:
a positive mask that specifies a viewable part of the at least one display screen,
a negative mask that specifies a non-viewable part of the at least one display screen,
a set of screen coordinates,
a bitmap, or
any combination thereof.

10. The method of claim 1,
wherein the controller is a programmable logic controller (PLC), or
wherein the controller is a non-PLC microcontroller.

11. The method of claim 1,
wherein the one or more sensors include at least one magnetic induction sensor or shaft encoder, or
wherein the one or more sensors include at least one optical image sensor, or
wherein the one or more sensors include a laser emitter and sensor, or
wherein the one or more sensors include a proximity sensor, or
any combination thereof.

12. The method of claim 1, wherein the determining determines not to transition the at least one display screen into the restricted mode.

13. The method of claim 1, wherein the determining determines to transition the at least one display screen into the restricted mode.

14. The method of claim 13, wherein the controller is communicatively coupled to a computing device that controls the at least one display screen, further comprising:
sending a signal to the computing device to trigger the computing device to transition the at least one display screen into the restricted mode based on the determining.

15. The method of claim 14, wherein a time period from the determining to the sending is less than about one second.

16. The method of claim 14, wherein the controller controls the at least one display screen, further comprising:
transitioning the at least one display screen into the restricted mode based on the determining.

17. The method of claim 16, wherein a time period from the determining to the transitioning is less than about one second.

18. The method of claim 1,
wherein the controller and the one or more sensors are communicatively coupled via a wired connection, or
wherein the controller and the one or more sensors are communicatively coupled via a wireless connection.

19. The method of claim 1, wherein the controller is integrated into or mounted onto the apparatus.

20. A method of operating a controller of a screen control system, comprising:
receiving, from one or more sensors associated with a human-operable apparatus while at least one display screen associated with the apparatus is in a restricted mode, sensor data that tracks motion and/or proximity of one or more apparatus components and/or a surrounding environment of the apparatus; and
determining whether to transition the at least one display screen into an unrestricted mode based on the sensor data,
wherein the restricted mode is characterized by a portion that comprises less than all of the at least one display screen being masked, and the unrestricted mode is characterized by the portion of the at least one display screen being unmasked, or
wherein the one or more sensors are configured to track at least non-propulsive motion of the one or more apparatus components of the human-operable apparatus, or
a combination thereof.

21. The method of claim 20, wherein the one or more sensors are configured to track at least the non-propulsive motion of the human-operable apparatus.

22. The method of claim 21, wherein the sensor data is further configured to track propulsive motion of the human-operable apparatus, non-propulsive motion of the human-operable apparatus, or a combination thereof.

23. The method of claim 20,
wherein the apparatus is a vehicle, or
wherein the apparatus is a stationary machine with one or more moving parts.

24. The method of claim 20, wherein the sensor data indicates a velocity and/or acceleration of the apparatus or one or non-propulsive more moving parts of the apparatus.

25. The method of claim 20, wherein the determining determines to transition the at least one display screen into the restricted mode based on whether the sensor data indicates the apparatus and/or the one or more apparatus components to be moving below velocity and/or acceleration thresholds.

26. The method of claim 20, wherein the restricted mode is characterized by the at least one display screen being blanked or completely masked, and the unrestricted mode is characterized by the at least one display screen being unblanked or completely viewable.

27. The method of claim 20, wherein the restricted mode is characterized by the portion that comprises less than all of the at least one display screen being masked, and the unrestricted mode is characterized by the portion of the at least one display screen being unmasked.

28. The method of claim 27, wherein a mask applied during the restricted mode is configured as:
a positive mask that specifies a viewable part of the at least one display screen,
a negative mask that specifies a non-viewable part of the at least one display screen,
a set of screen coordinates,
a bitmap, or
any combination thereof.

29. The method of claim 20,
wherein the one or more sensors include at least one magnetic induction sensor or shaft encoder,
wherein the one or more sensors include at least one optical image sensor, or
wherein the one or more sensors include a proximity sensor, or
wherein the one or more sensors include a laser emitter and sensor, or
any combination thereof.

30. A controller of a screen control system, comprising:
a memory; and
at least one processor coupled to the memory and configured to:
receive, from one or more sensors associated with a human-operable apparatus while at least one display screen associated with the apparatus is in an unrestricted mode, sensor data that tracks motion and/or proximity of one or more apparatus components and/or a surrounding environment of the apparatus; and
determine whether to transition the at least one display screen into a restricted mode based on the sensor data,
wherein the restricted mode is characterized by a portion that comprises less than all of the at least one display screen being masked, and the unrestricted mode is characterized by the portion of the at least one display screen being unmasked, or
wherein the one or more sensors are configured to track at least non-propulsive motion of the one or more apparatus components of the human-operable apparatus, or
a combination thereof.
